(19) United States
(12) Patent Application Publication
(10) Pub. No.: US 2017/0330459 A1
(43) Pub. Date: Nov. 16, 2017

(54) People Management System

(71) Applicant: Sharlyn Roach, Miami, FL (US)

(72) Inventor: Sharlyn Roach, Miami, FL (US)

(21) Appl. No.: 15/152,492

(22) Filed: May 11, 2016

(51) Int. Cl. G08G 1/127; G06Q 10/10; G06K 9/00; H04W 4/02; G06F 19/00

(52) U.S. Cl. CPC G08G 1/127; H04W 4/021; G06F 19/322; G06K 9/00771; G06Q 10/109

(57) ABSTRACT

A people management method comprised of a series of that records events automatically or manually on a computer relating to movement and location of a subject in the care of a caregiver. The computer maintains a record and notifies caregivers if expected preset conditions are not met. Optional features also include information about the subject made available to authorized caregivers.

### I. BACKGROUND OF THE INVENTION

### 1. Field of the Invention

The present invention relates to people management, and more particularly, to a software method and system to aid caregivers monitoring and managing people.

### 2. Description of the Related Art

Several designs for sign-in systems have been designed in the past. None of them, however, includes a comprehensive transportation management aspect with plural safeguards to maximize protection of cared for individuals, such as infants, school children or the elderly.

Other patents describing the closest subject matter provide for a number of more or less complicated features that fail to solve the problem in an efficient and economical way. None of the prior art teaches or suggests the novel features of the present invention.

### II. SUMMARY OF THE INVENTION

It is one of the main objects of the present invention to address a concern with the current process utilized for tracking/record keeping as it relates to the ingress/egress of children and the elderly while in custody at various schools, day cares, head start, after school care and adult day care facilities.

It is another object of this invention to provide the ability to e-track and e-record as it relates to the transportation services associated with cared for individuals.

It is still another object of the present invention to provide a ready data and communication platform to uniformly manage, protect and provide for the needs of those under the care and supervision of a caregiver.

It is yet another object of this invention to provide such a system that is inexpensive to deploy and maintain while retaining its effectiveness. Further objects of the invention will be brought out in the following part of the specification, wherein detailed description is for the purpose of fully disclosing the invention without placing limitations thereon.

### III. BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a flow chart of an example of the prior art.

FIG. 2 shows a flow chart of an example of a process.

### IV. DETAILED DESCRIPTION OF THE PREFERRED EMBODIMENT

The subject device and method of use is sometimes referred to as the device, the invention, the system, the method, IDIOT, the management system, machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation. In general, the present system is used to track, provide information and monitor the location and supervision of those under the care of others. For example, identifying and recording who picks up and drops off a child at daycare or a parent at eldercare. The system integrates this with recording times and locations of a transfer and also verifies the identity of the one picking up the person and the person being picked up. This can be applied equally as well to building facilities, temporary events, for transportation and any time or place where responsible tracking of cared for people is maintained.

The system is generally network based and is accessed on a properly logged on client computer. A central server may administer the software and store the data or it may be cloud based. Each client may be, for example, a handheld network device like a phone or a tablet or mounted into doorway access points or the like. The software to varying degrees of automation identifies and records the when and where of people moving around to ensure the safety of the cared for and ensure that they are at the right place at the right time.

Each client device ideally has a secure access authentication protocol to ensure that only those allowed to given access are permitted to engage on the system and retrieve information or permissions. Each device should also have a means to affirmatively identify those using the system and being monitored by the system. For example, secure login procedures, biometric scanning, signature verification, photo comparisons, facial recognition or other ways to positively identify a person interacting with the device as a user or the monitored person.

The system can be configured to record and/or deliver notifications to designated persons. This can be for normal level events or for unusual events. For example, a parent may or may not need to receive notification that a child returned to the classroom after recess. This would be a normal level event that would be recorded and logged by the system if it were ever needed but might not rise to the level of repeated daily notifications pushed to all caregivers. However, all could get the notices if so desired by that user.

On the other hand, a more unusual event might automatically be sent to all caregivers. For example, if a behavioral or medical issue was observed and recorded a parent may automatically be alerted by text message or email. This would typically be applied to events that are of particular interest to caregivers or an event that is out of the ordinary that may need special attention.

The system may have time triggers as well. For example, a child is recorded as entering a bus but more than a set period of time later (perhaps half an hour in this scenario) if that child is not recorded as entering the school then a more urgent notice is delivered to selected recipients to consider additional action.

A variety of reports may also be generated based on the data collected by the system. These could be, for example, attendance reports, confirmations of medicinal administration, flags for late arrivals, changes in behaviors like wake up times or toileting or for any other flagged or recorded event.

There may be entries for each person being monitored. For example a child at her elementary school may be the monitored. Associated with that child is the child's name and image for identification purposes. It could optionally include other identifiers such as biometric markers, facial or dental recognition patterns, finger prints or other uniquely identifying data. For that student there may also be other related information such as contact information for her and her parents. There may be special needs for the child such as medications, dietary restrictions or other noted particulars for that child. Along with this base information is the collected data about movements of the child including for example, ingress and egress times and locations, events that happen involving the child (i.e. disciplinary, missing backpacks, minor medical events or injuries) that are each recorded at or near the time of the occurrence.

The information gathered by the system may be queried by the caregiver to obtain information. For example, if the child is falling asleep in class the teacher could reference for medical conditions or a number to call parents for involvement. Or, a teacher could refer to medication schedules or learn of special needs of the child to provide a safer and happier school environment.

Obviously, any of these examples can be equally applied to seniors at adult daycare or nursing facilities, the learning disabled, prisons, hospitals and other facilities as context and need dictate and would be apparent in light of these descriptions.

In an important application of the system a camera and computer could be positioned at each bus door (or other vehicle door) and at points of facility entry (i.e. bus stop entrance, front door, classroom door . . . ) so that the movements of individuals is automatic. Merely passing in front of these strategically placed cameras causes the person to be identified (i.e. facial recognition) and the location and possible an image of proof also recorded.

In an example of a more manual adaptation of the system, a bus driver could have a tablet with access to the system and the driver or teacher could manually identify and log an event (i.e. on or off the bus) while still having the features of having this information accessible by others authorized on the network (i.e. a principal, teacher or parent) to care for the child. This version can also include any of the other features of the system like notifications and availability of the child's personal information to provide better services to them.

An optional module included with the system is a disciplinary management system. This could include any incidents involving the supervised so any patterns of behavior could be easier to identify and address. There may be special monitoring needs related to behavior that require immediate parental notice in a school setting or correctional officer notice in a prison. Behavior information may be more sensitive so permission to access could be limited as compared to other information available to caregivers on the system.

An optional medical module may also be integrated with particulars of any cared for individual. Like the behavioral module security and privacy concerns may limit access to specifically authorized caretakers. Medical information could be nurses noted, confirmation of medicine administration, medical treatment instructions, specific behavioral stressors or ways to deal with the cared for person or other person specific information that could be helpful to the caregiver to provide safety and security to the cared for person.

The system may be server or cloud based. It would be beneficial for the system to have a central repository of information or other means to ensure that the information at each terminal accessed by the caregivers is current and accurate. This is one of the key failings of the paper system previously used because each paper record is instantly stale the time another copy is changed.

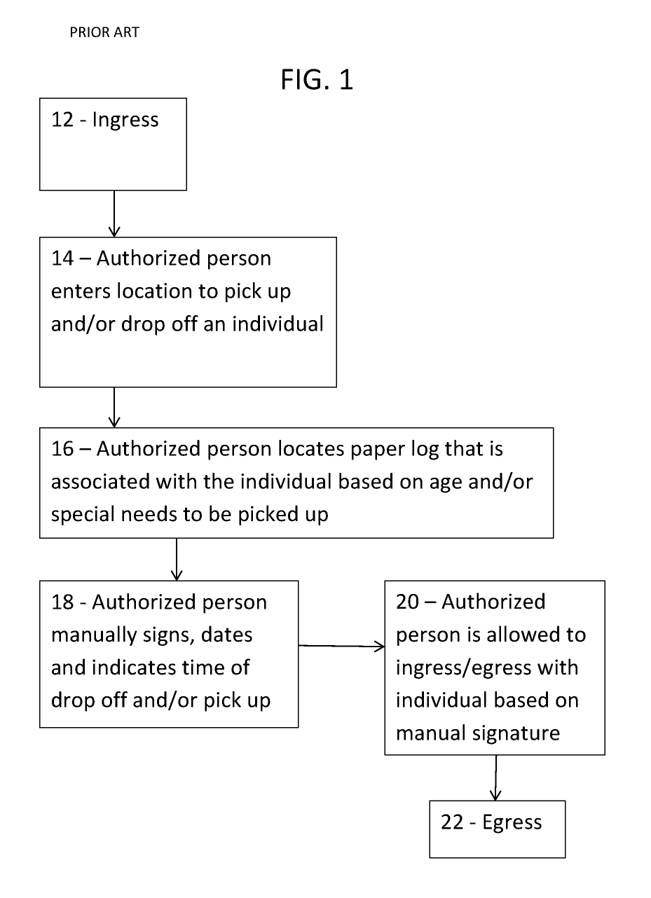

Referring now to the drawings, where the prior art is generally described in FIG. 1. It can be observed that it starts at step 12 at ingress. At step 14 an authorized person enters a location, such as a daycare or school, to pick up or drop off an individual under their care. In step 16 the authorized individual locates a paper log, typically near an entrance to the building or vehicle, which includes a place to record written information about the individual and/or special needs information about the person to be picked up. The authorized person, in step 18, signs and records date and time of the pick up or drop off to create a record of the event. Authorization is granted to ingress or egress in step 20 and egress is effected in step 22 completing the transaction.

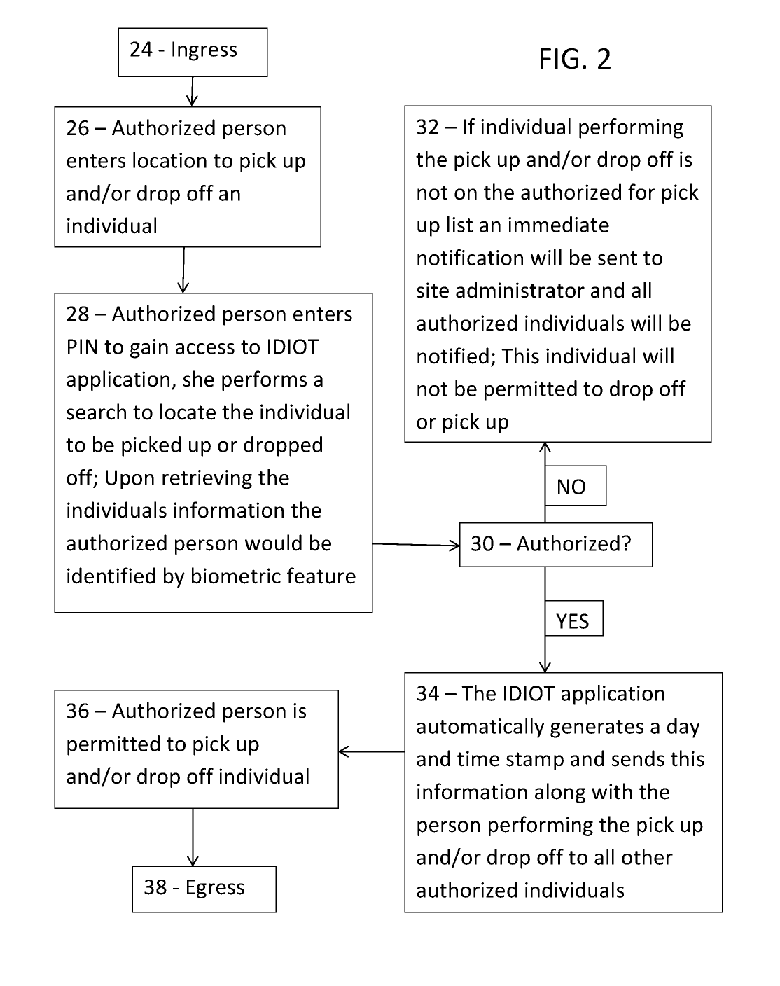

A summary example of the present improved system is demonstrated in part in FIG. 2 in flow chart format. The step 24 of ingress and step 26 where an authorized person enters a location like a school or nursing home to pick up or drop off an individual. Here, however the improvements become apparent in step 28 where an authorized person enters a valid PIN to access the IDIOT system. Alternatives include, for example, a password or biometric confirmation to gain access. The authorized person can then search to locate the individual to be picked up or dropped off. The person being picked up may then be confirmed by another PIN, password, biometric scan or other confirmation means to affirmatively identify the person.

Continuing the example in FIG. 2, if the identifications are confirmed then the system determines in step 30 whether the individuals are authorized. If authorization is not determined then in step 32 the person doing the pick up or drop off is denied access and a notification can be sent to an administrator and any selected authorized individuals associated with the person being picked up or dropped off. If on the other hand the identities and authorizations are confirmed as authorized, then in step 34 the system records a time and date stamp of the occurrence and notifies appropriate individuals of the access granted. This might be helpful if mom is notified while at work that dad remembered to pick up the little one from daycare. Then in step 36, that person is given access to the person and permitted to egress in step 38.

According to recent statistics from the Florida Department of Children and families there are 1,540 licensed facilities in Miami Dade County that care for children and adults. For example, there are 273 Miami Dade County Public Schools, of which 221 operate aftercare school programs. There are 300 afterschool programs sponsored by The Children's Trust, 100 Head Start programs under the Early Head Start Division, thirty two Fit2Play afterschool programs sponsored by Miami Dade Parks & Recreation, fifty seven YMCA afterschool care programs, five afterschool programs sponsored by Boys and Girls Clubs of Miami, five Miami Dade County Adult Day care centers as well as many other public and private programs. Other jurisdictions have similar types of programs commensurate with the population.

Currently, in most cases the tracking mechanism is a paper log spreadsheet that is used to sign an individual in and out of a particular facility. In the case for minors, there are various grade levels and/or income-based programs associated with each individual. There are usually more than one paper log for a particular facility. In many cases there could be an excess of six paper logs, one log for each grade level which may not include additional logs for income-based programs. For example, an administrator may have one copy, the bus entrance supervisor another copy and a front door reception may have yet another log book.

There is great safety implications that dictate that the child shall not be released to any person other than the person(s) authorized by the custodial parent or legal guardians. Typically this would include close family, babysitters, adult care providers and other specifically designated responsible persons.

The current pager log process is an extremely costly and not eco-friendly. It is also subject to frequent error and an unreliable measure of tracking, record keeping and identification. With multiple analog logs there is no way to ensure that all information contained thereon is accurate and up to date in all forms.

Paper logs also create a security risk. Personal information, including location and patterns of travel, may be accessed without any evidence of data loss. This could be as simple as someone signing in being able to see names and times that others were signed in. In most cases this is generally benign information. However, there are situations where this tracking information and other information associated with that individual should remain more secure.

This process could generally allow an unauthorized individual access to an individual in any of the above mentioned facilities thus decreasing security and increasing safety concerns. In addition, this paper process of record keeping is antiquated, subject to lost, theft, wear and tear, water and/or fire damage, it is not easily accessible and retrievable for audit purposes.

The historically used paper system should not be deemed as a reliable source for identification and auditing purposes. It must be replaced immediately by an automated identification, e-notify and data management system method and related devices.

The present invention can be characterized as an Individual Daily In/Out Tag (IDIOT) e-notify biometric identity systems application to replace the current antiquated paper log process. The IDIOT e-notify system application is a network or web-based application used, for among other reasons, to track the ingress and egress of individuals in schools, aftercares, day cares, head start, adult day care facilities, and the transportation services associated with these individuals.

The system will immediately identify whether an individual is authorized or not-authorized to pick up or drop off a person, it will immediately notify all other authorized individuals, for example via text message/email, when an individual has been picked up and/or dropped off, along with the name of the individual, date & time of pick up and/or drop off. The IDIOT e-notify system will immediately notify site administrators and all authorized persons, if an unauthorized person is attempting to pick up and/or drop off an individual.

The IDIOT e-notify system will optionally also send an alert when a particular individual has not been picked up by the designated time. The system may also provide instant mass notification & alerts in the case of an emergency directly to a caregiver.

Transportation Module:

The prior art does not sufficiently provide for an e-track, e-notify system in place for individuals that are being transported to and from various schools, day cares, head start, after school care and adult day care facilities.

The IDIOT system and application software will track individuals as they ingress and egress a vehicle, such as a bus, while being transported. The IDIOT e-notify system application will immediately identify and record the vendor (service provider), vehicle tag and driver information associated with each passenger transported. The IDIOT e-notify system application will optionally immediately notify all authorized individuals via text message/email when an individual has been picked up and/or dropped off, along with the name of the vendor, vehicle tag and driver information along with the date and time of pick up and/or drop off. An administrator or user of the system may selectively control which notifications are sent.

The individual receiving the person being transported will also be e-tracked. The IDIOT e-notify system application will perform checks and balances throughout this process to ensure that all passengers have been accounted for. This will eliminate the growing concern of passengers being left on vehicles, of which some have resulted in death.

Prior Art Process Flow:

The majority of schools, aftercares, daycares and adult day cares utilize a paper log in and log out sheet to track when a particular individual is picked up or dropped off. There are usually several logs sorted by age group and/or a particular program type. The name of the individual, date and time is hand written and signed by the individual doing the drop off and/or pick-ups. There is no immediate identifiable measure in place in the prior art to verify that the person is authorized to pick up an individual.

IDIOT Process Flow:

In a version of the system, a network or web-based application with biometric e-signature/e-notify replaces the prior manual process. The network or web-based application Individual Daily In/Out Tag (IDIOT) e-notify biometric identity systems application will immediately verify if the person is authorized or not-authorized for pick-up. The IDIOT e-notify system will automatically notify all authorized persons that an individual has been dropped off or picked-up, the name, date and time of drop off or pick-up will be displayed. The IDIOT system will begin to notify authorized persons when a particular individual has not been picked up by the designated time, these notifications will start, for example, about fifteen minutes after the designated time has expired. This time may be adjusted based on the specific situation.

Government Compliance

According to the Florida Department of Children and Families, the Florida Administrative Code Child Care Standards regarding record keeping and enrollment information states the child shall not be released to any person other than the person(s) authorized or in the manner authorized in writing by the custodial parent or legal guardians. The IDIOT e-notify system will facilitate compliance with this code and others like it around the country.

Application Design/Development Phase

The IDIOT e-notify systems application is operable in various phases. Phase 1 includes the implementation of the module that will be used to track and identify authorized/non authorized individuals as they pick up and drop off various individuals. Phase 2 includes the implementation of the transportation module which will track individuals as they ingress and egress while being transported.

Security, Auditing and Database Requirements

The IDIOT e-notify system application provides role based security. The roles will determine the inquiry levels and/or extent of modification that a user can perform.

Selectively, registered IDIOT e-notify system application users will be given inquiry capabilities. Authorized individuals will establish a biometric signature along with a Personal Identified Number (PIN). Transactions will store the current date, current time, individual being picked up and/or dropped off, and the user performing the transaction. This will serve as an auditing mechanism. The IDIOT e-notify systems application will interface with a current version of SQL Server database.

Hardware Elements

Biometric identification devices can be integrated with each computing device on the system. For example, fingerprint scanners, facial recognition or other means can be used to authenticate both the person transported as well as the user to authenticate access onto the system to gain information and communication.

The IDIOT App will be available for installation on any mobile computing device. Portability allows authorized users to have immediate access to an individual's general information.

Reports

Reports will be viewable online under the reports option. For example, any individual or combination of the following may be made available by the system: a detailed daily listing log report of active individuals, a detailed monthly listing log report of active individuals, a detailed daily list of individuals picked up after scheduled time, a detailed monthly list of individuals picked up after scheduled time, a list of authorized for pick-ups, a list of non-authorized for pick-ups, a list of administrators or administrators will also have the ability to create ad-hoc reports based on need. Other reports may be made or disseminated as needed by a particular implementation of the system.

A version of the present method and related devices can be fairly described as a method for people management comprising a computer, a checkpoint module and a transportation module all electronically in communication. A first caregiver, such as an administrator, has responsibility for a predetermined subject, such as a student, infant or elder. The computer is operatively in communication with a computer network to facilitate communication between the various people and components. A fixed checkpoint is established at a preselected location, for example at an entranceway. When the subject reaches the first checkpoint the checkpoint module records on the computer a first information comprised of a unique identity of the subject and the time the subject reached the fixed checkpoint. For example, student A passed the front door at a specific time. A mobile checkpoint is established at a preselected vehicle, for example a school bus. When the subject enters the vehicle at the mobile checkpoint the transportation module records on the computer a second information comprised of the unique identity of the subject, the time the subject reached the mobile checkpoint and the location of the mobile checkpoint. This provides proof that the subject entered or exited the vehicle at a specific time. When the subject exits the vehicle at the mobile checkpoint the transportation module records on the computer a third information comprised of the unique identity of the subject, the time the subject reached the mobile checkpoint and the location of the mobile checkpoint. The computer autonomously sends a notification to a second caregiver, for example a parent or teacher, about the subject upon the occurrence of a preselected event. The preselected event may be occurrence of and event (i.e. the subject entered the front door) or lack of an expected occurrence (i.e. the subject did not enter the front door before a set time or many other triggers). The computer sends a notification to the second caregiver about the subject at the direction of the first caregiver. The first caregiver or the second caregiver retrieves any of the first, second or third information to verify or check on the subject. A report including any of the first information, second information or third information is compiled by the computer and is provided to the first caregiver or second caregiver via the computer network. This might be emailed, texted or otherwise communicated. The checkpoint module automatically records the first information using a biometric identification means to uniquely identify the subject. For example, iris scan, facial or voice recognition, a fingerprint, a signature or other unique and recordable feature. Instead of a biometric, it could be an access card, chip or other carried credentials. The computer makes available to an authorized caregiver disciplinary information about the subject. This could be an alert of bad behavior or other such information that needs caregiver attention. The computer makes available to an authorized caregiver medical information about the subject. This could be about medications, allergies, medical conditions that need special accommodation or other pertinent health related information to aid in providing care to the subject. An example of a preselected event is any of: (a) not recording a third information within a preset interval of recording a second information (i.e. not getting off the bus), (b) not recording a first information within a preset interval of recording a third information (i.e. not going into the building after getting off the bus), or (c) not recording a second information within a preset interval of recording a first information (i.e. not getting onto the bus after exiting the building).

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A method for people management comprising a server, a checkpoint client module and a transportation client module;
a caregiver has responsibility for an individual in the caregiver's custody;
the server is operatively in communication with a computer network;
checkpoint client module is located at a preselected location;
when the individual reaches the checkpoint client module the checkpoint client module records and delivers to the server a first information comprised of a unique identity of the individual and the time the individual reached the checkpoint client module;
the transportation client module is located in a preselected vehicle;
when the individual enters or exits the vehicle the transportation client module records and delivers to the server a second information comprised of the unique identity of the individual, the time the individual reached the transportation client module and the location of the vehicle;
when the individual exits the vehicle the transportation client module records and delivers to the server a third information comprised of the unique identity of the individual, the time the individual reached the transportation client module and the location of the vehicle;
the server compares the first information to a preselected designated time and location of the individual and if the server determines that the first information and the preselected time and location of the individual do not match then the server sends an autonomous visual or audible report to the caregiver;
a guardian of the individual takes custody and responsibility of the individual from the caregiver either (a) at the checkpoint client module after the server indicates visually or audibly to the caregiver that the guardian is authorized to take custody of the individual and the checkpoint client module records and delivers to the server a time, location and identity of the guardian, or (b) at the transportation client module after the server indicates visually or audibly to the caregiver that the guardian is authorized to take custody of the individual and the transportation client module records and delivers to the server a time, location and identity of the guardian.

2. The method for people management in claim 1 further characterized in that the checkpoint module automatically records the first information using a biometric identification means to uniquely identify the individual.

3. The method for people management in claim 1 further characterized in that the computer makes available to an authorized caregiver disciplinary information about the individual.

4. The method for people management in claim 1 further characterized in that the computer makes available to an authorized caregiver medical information about the individual.

5. The method for people management in claim 1 further characterized in that the preselected event is any of: (a) not recording a third information within a preset interval of recording a second information, (b) not recording a first information within a preset interval of recording a third information, or (c) not recording a second information within a preset interval of recording a first information.

6. A method for people management comprising a server, a checkpoint client module and a transportation client module;
a caregiver has responsibility for an individual in the caregiver's custody;
the server is operatively in communication with a computer network;
checkpoint client module is located at a preselected location;
when the individual reaches the checkpoint client module the checkpoint client module records and delivers to the server a first information comprised of a unique identity of the individual and the time the individual reached the checkpoint client module;
the transportation client module is located in a preselected vehicle;
when the individual enters or exits the vehicle the transportation client module records and delivers to the server a second information comprised of the unique identity of the individual, the time the individual reached the transportation client module and the location of the vehicle;
when the individual exits the vehicle the transportation client module records on the server a third information comprised of the unique identity of the individual, the time the individual reached the transportation client module and the location of the vehicle;
the server compares the first information to a preselected designated time and location of the individual and if the server determines that the first information and the preselected designated time and location do not match then the server send an autonomous visual or audible report to the caregiver;
a guardian of the individual takes custody and responsibility of the individual from the caregiver either (a) at the checkpoint client module after the server indicates visually or audibly to the caregiver that the guardian is authorized to take custody of the individual and the checkpoint client module records and delivers to the server a time, location and identity of the guardian, or (b) at the transportation client module after the server indicates visually or audibly to the caregiver that the guardian is authorized to take custody of the individual and the transportation client module records and delivers to the server a time, location and identity of the guardian;
the checkpoint module automatically records the first information using a biometric identification means to uniquely identify the individual;
the computer makes available to an authorized caregiver disciplinary information or medical information about the individual;
the preselected event is any of: (a) not recording a third information within a preset interval of recording a second information, (b) not recording a first information within a preset interval of recording a third information, or (c) not recording a second information within a preset interval of recording a first information.

7. A method for people management comprising a server, a stationary checkpoint module and a transportation checkpoint module;
prerecorded on the server is a first information comprising an expected time and location of an individual;
the stationary checkpoint module is physically located at a preselected first checkpoint;
the stationary checkpoint module is comprised of a first computer operatively connected to a biometric identification module and the server;
when passing the first checkpoint an identity of the individual is established by the biometric identification module and a first time is recorded by the stationary checkpoint module;
the stationary checkpoint module sends the identity and the first time to the server;
the server compares the first time and the expected time and if the first time and the corresponding expected time do not match then a first information is delivered to a caregiver in a visual or audible format;
the transportation checkpoint module is physically located at a preselected second checkpoint on a vehicle;
the transportation checkpoint module is comprised of a second computer operatively connected to a biometric identification module and the server;
when passing the second checkpoint an identity of the individual is established by the biometric identification module and a second time is recorded by the transportation checkpoint module;
the transportation checkpoint module sends the identity and the second time to the server;
the server compares the second time and the expected time and if the second time and the corresponding expected time do not match then a second information is delivered to a caregiver in a visual or audible format.
